(19) United States
(12) Patent Application Publication
(10) Pub. No.: US 2021/0030026 A1
(43) Pub. Date: Feb. 4, 2021

(54) LOW-CALORIE HERBAL ENERGY DRINK

(71) Applicant: Physis Products LLC, East Calais, VT (US)

(72) Inventor: Heather Beach, East Calais, VT (US)

(73) Assignee: Physis Products LLC, East Calais, VT (US)

(21) Appl. No.: 16/525,419

(22) Filed: Jul. 29, 2019

(51) Int. Cl. A23L 2/02; A23L 2/60; A23L 33/105; A23L 33/125; A23L 29/00; A23F 5/24

(52) U.S. Cl. CPC A23L 2/02; A23L 2/60; A23F 5/24; A23L 33/125; A23L 29/045; A23L 33/105

(57) ABSTRACT

The present disclosure is drawn to a low-calorie, low caffeine herbal energy drink for enhancing mood and well-being comprising an infusion of Schisandra berries, coffee beans, fenugreek seed, Cardamom seed and supplemented with a natural sweetener, such as maple syrup. The energy drink does not contain any artificial flavors, sweeteners or preservatives.

### FIELD OF THE EMBODIMENTS

This invention relates to an energy drink comprising an infusion of all-natural herbal ingredients.

### BACKGROUND OF THE EMBODIMENTS

The demand for energy drinks that claim to enhance mental and physical wellness has increased markedly over the past decade. Many of these drinks rely on stimulants of the central nervous system, such as a caffeine supplement, to boost a drinker's energy level. The addition of caffeine to many soft drinks (“colas”), energy drinks, chocolate and over-the-counter pain medications is becoming ever more pervasive (see FIG. 1). However, the consumption of caffeine is not without potential health risks. A study on the effect of daily caffeine use on cerebral blood flow found that caffeine, a vasoconstrictor, could reduce cerebral blood flow by an average of 27 percent. Caffeine consumption can also lead to dehydration as a result of a diminished release of ADH (antidiuretic hormone) and the subsequent reduction in the reabsorption of water by the kidneys. Moreover, according to the FDA, regular consumers of coffee (i.e., about 100 milligrams of caffeine per six ounces of drip coffee), run the risk of developing tolerance and eventual dependence on the drug. Caffeine, especially if consumed late in the day, is also known to interfere with an individual's sleep quality or cause insomnia which has been linked to the onset of diabetes, mood disorders, and obesity. Once established, addiction to caffeine is also difficult to overcome primarily because caffeine withdrawal can result in headaches, depression, fatigue, and overall irritability.

There is therefore a need for energy drinks that have a positive impact on mental and physical stamina without increasing the intake of caffeine.

Examples of related art are described below:

U.S. Patent Application No. 2008/0199586 relates to fruit drinks, concentrates, and methods for providing positive health benefits to an individual. In one embodiment, a fruit-based drink or drink concentrate can comprise longan; a berry selected from the group consisting of lycium berry, hawthorne berry, Schisandra berry, seabuckthorn berry, and mixtures thereof; and an herb selected from the group consisting of astragalus, jujube date, coriolus versicolor, rhodiola rosea, and mixtures thereof. In another embodiment, the fruit-based drink or concentrate can comprise apple juice; a secondary fruit juice selected from the group consisting of pineapple, white grape, pear, and mixtures thereof; a fruit or herb selected from the group consisting of euphoria longan, lyceum berry, astragalus, jujube date, gac, cili, seabuckthorn berry, coriolus versicolor, durian, and mixtures thereof. Such fruit-based drinks can be used to provide added nutrition to the diet, aid in the prevention of certain diseases, offset the consequences of poor health choices, and reduce or slow down some of the effects of aging on the body.

The European patent EP1532868 discloses an extract of wolfberries (Lycium barbarum) combined with an extract of Schisandra berries (Schisandra chinensis) and magnolia blossom as a food supplement. The mixture is free of Schisandra seeds and/or their components. The mixture is prepared as an instant tea powder, tea bags, confectionery, jam, etc.

U.S. Patent Application No. 2017/0224757 relates to compositions containing natural and botanical extracts for use in inhibiting one, two, or three of (a)-(c): (a) demethylation of PP2A by PME-1 methylesterase; (b) formation of free radicals and reactive oxygen species; and/or (c) inflammation. These compositions include an extract of one or more botanicals selected from the group consisting of: juniper berry fruit, Schisandra fruit, strawberry fruit, avocado seeds, black raspberry seeds, blueberry seeds, celery seeds, cranberry seeds, fennel seeds, grape seeds, guarana seeds, red raspberry seeds, maca root, goldenseal root, turmeric root, magnolia bark, pygeum bark, red raspberry leaf, almond, cocoa powder, Echinacea angustifolia, prickly pear cactus and walnut.

U.S. Patent Application No. 2015/0342237 relates to various compositions for controlling body weight and/or for promoting weight loss. The invention also relates to methods of using these compositions and kits including these compositions to control body weight and/or promote weight loss.

U.S. Patent Application No. 2015/0190450 relates to an ingredient for consumption and application is created in various methods and forms so that the ingredient is available for the consumer in a convenient, effective, and efficient manner. The ingredient includes plant ingredient, chinese medicine, nutritional ingredient, health ingredient, cleansing ingredient, and food additive. Ingredient for consumption and application comprising at least one ingredient. The ingredient having nutrients including carbohydrates, vitamins, minerals, and antioxidants; having medicinal properties; and having cleansing properties. The ingredient is in form selected from group consisting of skin, skinned, unskinned, unshelled, cut, uncut, extract, juice, sauce, liquid, oil, gel, jelly, wax, cream, paste, powder, thin layer, small particles, small and large pieces. The ingredient can be uncooked; and cooked by method selected from group consisting of deep frying, sun drying, roasting, baking, steaming, boiling, grilling, and frying. The ingredient can be added to various fabric and medium.

U.S. Patent Application No. 2015/0181917 relates to plant powder, plant bag, and dried plant are created with a wide range of various ingredients. Plant powder, plant bag, and dried plant are created comprising at least one plant ingredient, with at least one flavoring. At least one plant ingredient having nutrients including carbohydrates, vitamins, minerals, and antioxidants. At least one plant ingredient is in form selected from group consisting of plant powder, plant bag, and dried plant. At least one plant ingredient is selected from group consisting of herb, tea, root, flower, flower bud, pollen, stem, stem shoot, leaf, bulb, cereal grain, nut, seed, bean, fruit, fruit skin, vegetable, and vegetable skin. At least one plant ingredient can further comprise addition of at least one nutritional ingredient, and at least one food additive. At least one flavoring is selected from group consisting of bland, sweet, sour, bitter, salty, spicy, and pungent.

U.S. Patent Application No. 2014/0234488 to a beverage system is created having beverage, with at least one liquid. The beverage is created in a variety, including tea drink, coffee, milk drink, yogurt drink, malted drink, roasted cereal grain beverage, roasted nut and seed beverage, roasted bean beverage, distilled water, mineral water, sports drink, fruit juice, vegetable juice, fruit drink, vegetable drink, fruit skin drink, vegetable skin drink, plant drink, soft drink, alcoholic drink, and soup drink. The beverage is also created with or without addition of ingredient, including flavoring ingredient, nutritional ingredient, health ingredient, and other ingredient. The beverage can be served as hot drink, cold drink, cold drink with ice, and warm drink. The beverage can be caffeinated, or non-caffeinated; and diet or non-diet. The liquid includes water, oil, and alcohol. The beverage system is created in various form, including bubble beverage, instant beverage, and beverage with dissolved gas.

U.S. Patent Application No. 2004/0180104 relates to a new herbal composition for the prevention and/or treatment of the conditions in associated with depression. Also provided is a method of treating and/or preventing the conditions associated with depression by administering the herbal composition of the invention.

None of the art described above teaches or suggests a low calorie, low caffeine composition for enhancing energy and mental stamina comprising an infusion of Schisandra berries, coffee beans, fenugreek seed, cardamom seed supplemented with maple syrup.

### SUMMARY OF THE EMBODIMENTS

In a first aspect, a composition for enhancing energy and mental stamina is disclosed that comprises an infusion of Schisandra berries and caffeine-containing fruit.

In certain embodiments of the first aspect, the composition does not contain artificial flavors, artificial sweeteners or artificial preservatives.

In certain embodiments of the first aspect, the composition self acidifies.

In certain embodiments of the first aspect, the composition self acidifies to a pH of about 2 to about 5.

In certain embodiments of the first aspect, the caffeine-containing fruit comprises coffee beans.

In certain embodiments of the first aspect, wherein the coffee beans are roasted.

In certain embodiments of the first aspect, wherein the composition further comprises a steeped extract of fenugreek seeds.

In certain embodiments of the first aspect, wherein the composition further comprises a steeped extract of cardamom seed.

In certain embodiments of the first aspect, wherein the composition further comprises about 6% (w/w) natural sweetener.

In certain embodiments of the first aspect, wherein the natural sweetener comprises maple syrup.

In certain embodiments of the first aspect, an ounce of the composition comprises from about 0.1 to about 11 mg of caffeine.

In certain embodiments of the first aspect, an ounce of the composition comprises from about 5 to about 11 mg of caffeine.

In certain embodiments of the first aspect, an ounce of the composition comprises less than 10 calories.

In certain embodiments of the first aspect, an ounce of the composition comprises about 2 grams of sugar.

In certain embodiments of the first aspect, a beverage is disclosed that comprises any one of the preceding embodiments of the composition.

In a second aspect, a composition for enhancing energy and mental stamina is disclosed that consists of a steeped extract of Schisandra berries, coffee beans, fenugreek seed, cardamom seed and a natural sweetener.

In a third aspect, a method for enhancing energy and mental stamina of a subject is disclosed comprising consuming the beverage of any one of the preceding embodiments of the composition.

In a fourth aspect, a method for making a beverage for enhancing energy and mental stamina is disclosed comprising steeping Schisandra berries, coffee beans, fenugreek seeds and cardamom seed in water, and adding a natural sweetener, such as maple syrup.

### BRIEF DESCRIPTION OF THE DRAWINGS

FIG. 1 shows an exemplary list of energy drinks with serving size and mg of caffeine;

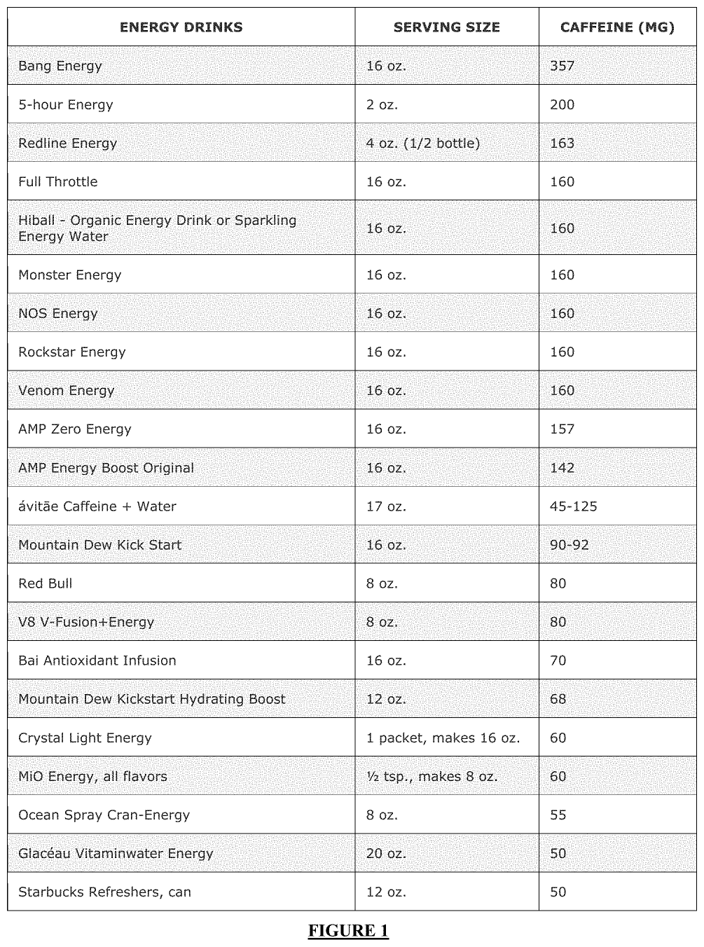

FIG. 2A shows an exemplary list of ingredients found in an herbal energy drink;

FIG. 2B shows an exemplary assessment of microbes found in an herbal energy drink;

FIG. 2C shows an exemplary depiction of the self-acidification of an herbal energy drink as a function of time.

### DESCRIPTION OF THE PREFERRED EMBODIMENTS

The preferred embodiments of the present invention will now be described. Such embodiments are provided by way of explanation of the present invention, which is not intended to be limited thereto. Those of ordinary skill in the art may appreciate upon reading the present specification and viewing the present drawings that various modifications and variations can be made thereto.

### Definitions

As used herein, the singular forms “a,” “an,” and “the,” are intended to include the plural forms as well, unless the context clearly indicates otherwise.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, an “embodiment” means that a particular feature, structure or characteristic is included in at least one or more manifestations, examples, or implementations of this invention. Furthermore, the particular features, structures or characteristics may be combined in any suitable manner, as would be apparent to a person skilled in the art. Combinations of features of different embodiments are ail meant to be within the scope of the invention, without the need for explicitly describing every possible permutation by example. Thus, any of the claimed embodiments can be used in any combination.

The phrase “and/or,” as used herein in the specification and in the claims, should be understood to mean “either or both” of the elements so conjoined, i.e., elements that are conjunctively present in some cases and disjunctively present in other cases. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

When the term “about” is used in conjunction with a numerical range, it modifies that range by extending the boundaries above and below those numerical values. In general, the term “about” is used herein to modify a numerical value above and below the stated value by a variance of 20%, 10%, 5%, or 1%. In certain embodiments, the term “about” is used to modify a numerical value above and below the stated value by a variance of 10%. In certain embodiments, the term “about” is used to modify a numerical value above and below the stated value by a variance of 5%. In certain embodiments, the term “about” is used to modify a numerical value above and below the stated value by a variance of 1%.

When a range of values is listed herein, it is intended to encompass each value and sub-range within that range. For example, “1-5 ng” is intended to encompass 1 ng, 2 ng, 3 ng, 4 ng, 5 ng, 1-2 ng, 1-3 ng, 1-4 ng, 1-5 ng, 2-3 ng, 2-4 ng, 2-5 ng, 3-4 ng, 3-5 ng, and 4-5 ng.

As referred to herein, all compositional percentages are by weight of the total composition, unless otherwise specified. As used herein, the word “include,” and its variants, is intended to be non-limiting, such that recitation of items in a list is not to the exclusion of other like items that may also be useful in the compositions and methods of this technology. Similarly, the terms “can” and “may” and their variants are intended to be non-limiting, such that recitation that an embodiment can or may comprise certain elements or features does not exclude other embodiments of the present technology that do not contain those elements or features.

As used herein, “concentrate” refers to a concentrated form of the disclosed composition, which is formed by any conventional means, usually by the removal of water.

As used herein, the term “extract” is used generally and encompasses herbal derived aqueous extracts, non-aqueous extracts, distillates, and infusions unless expressly and specifically indicated otherwise, which are biologically and therapeutically active.

As used herein, “herb” or “herbal” is used generally to refer to a plant and/or part of a plant including the seed, root, stem, leaf, flower, and/or fruit that contains compounds of medicinal, nutritional, gustatory, and/or aromatic value.

“Maple syrup” when used herein means the concentrated sap of trees of the botanical genus Acer.

As used herein, the term “beverage” refers generally to any liquid or semi-solid form suitable for oral consumption by an individual that is now known or becomes known by those skilled in the art. In certain embodiments, a “beverage” may include concentrates, for example, frozen concentrates, and freeze-dried powders that can be dissolved in a suitable volume of liquid carrier to generate a, so called, “instant” liquid or semi-solid for consumption by an individual.

### Herbal Energy Drink

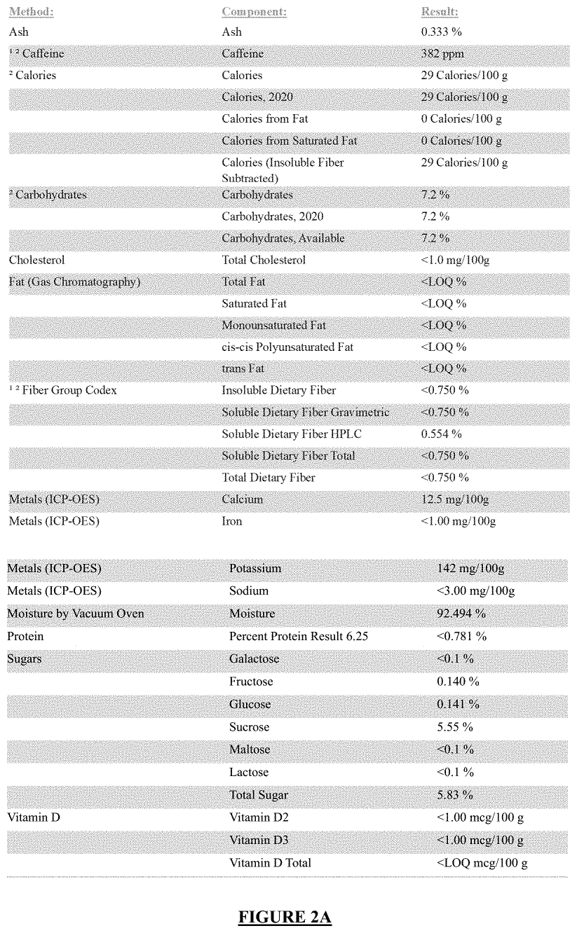

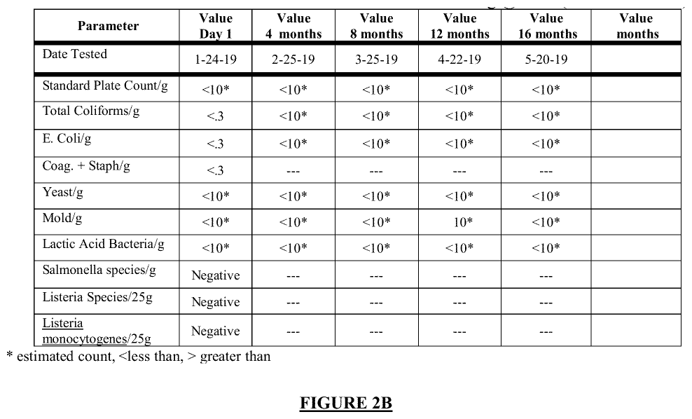

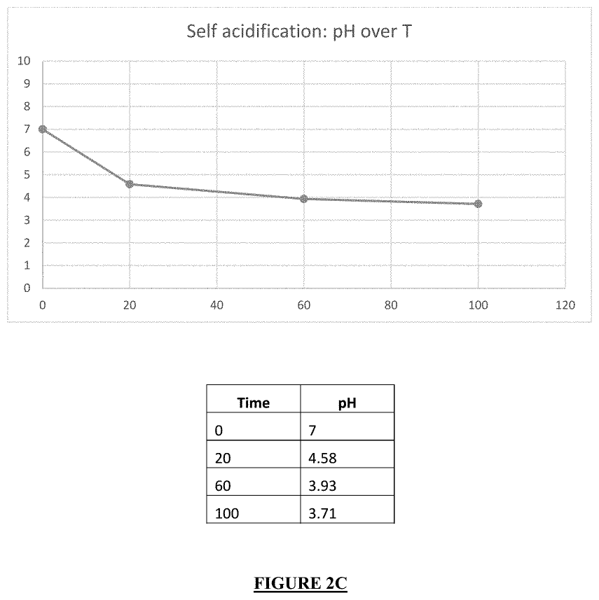

The present disclosure is drawn to a low-calorie, low caffeine herbal energy drink comprising an infusion of Schisandra berries, caffeine-containing fruit, fenugreek seed, Cardamom seed and supplemented with a natural sweetener, such as maple syrup. The energy drink does not contain any artificial flavors, sweeteners or preservatives (see FIG. 2A).

According to the FDA, the term “artificial flavor” or “artificial flavoring” means “any substance, the function of which is to impart flavor, which is not derived from a spice, fruit or fruit juice, vegetable or vegetable juice, edible yeast, herb, bark, bud, root, leaf or similar plant material, meat, fish, poultry, eggs, dairy products, or fermentation products thereof.” A listing of artificial flavoring agents can be found at 21 CFR 172.515 entitled “Synthetic flavoring substances and adjuvants,” the content of which is incorporated by reference herein in its entirety.

According to the FDA, the term “artificial preservative” as defined by 21 CFR 101.22(a)(5), “means any chemical that, when added to food tends to prevent or retard deterioration thereof, but does not include common salt, sugars, vinegars, spices or oils extracted from spices, substances added to food by direct exposure thereof to wood smoke, or chemicals applied for their insecticidal or herbicidal properties”.

Artificial chemical preservative, include, for example, ascorbic acid, erythorbic acid, sorbic acid, thiodipropionic acid, ascorbyl palmitate, butylated hydroxyanisole, butylated hydroxytoluene, calcium ascorbate, calcium sorbate, dilauryl thiodipropionate, potassium bisulfite, potassium metabisulfite, potassium sorbate, sodium ascorbate, sodium bisulfite, sodium metabisulfite, sodium sorbate, sodium sulfite, sulfur dioxide or tocopherols (see 21 CFR 182, the content of which is incorporated by reference herein in its entirety). In certain embodiments, artificial preservatives can be, for example, butylated hydroxyanisole (BHA), butylated hydroxytoluene BHT and mixtures thereof.

As used herein, artificial sweeteners can be, for example, refined brown sugar, fructose, dextrose, sucrose, granulated sugar, rock sugar, powdered sugar, cane sugar and mixtures thereof and artificial non-nutritive sweeteners can be, for example, saccharine, cyclamates and aspartame and mixtures thereof.

As used herein, a natural sweetener can be, for example, maple syrup or honey.

In certain embodiments, the herbal energy drink comprises ingredients solely from natural sources that contain no artificial additives including chemically modified ingredients.

In certain embodiments, the herbal energy drink does not include refined, purified or partially purified ingredients of a natural foodstuff.

In certain embodiments, the herbal energy drink does not contain processed foods such as high-fructose corn syrup, artificial dyes, trans fats, fruit or vegetable juices, canned food, packaged food and food additives such as sodium nitrate, propyl, monosodium glutamate, and bromate.

In certain embodiments, the herbal energy drink does not comprise a fermentation process.

In certain embodiments, the herbal energy drink does not include alcohol. As used herein, an “infusion” refers to an extract obtained from steeping herbal ingredients in a liquid, e.g. water.

In certain embodiments, the extract can be a water-soluble extract.

In certain embodiments, the herbal ingredients include at least one of Schisandra berry, caffeine-containing fruit, fenugreek seed and Cardamom seed.

In certain embodiments, the herbal ingredients include at least two of Schisandra berry, caffeine-containing fruit, fenugreek seed and Cardamom seed.

In certain embodiments, the herbal ingredients include at least three of Schisandra berry, caffeine-containing fruit, fenugreek seed and Cardamom seed.

In certain embodiments, the herbal ingredients include Schisandra berry, a caffeine-containing fruit, fenugreek seed and Cardamom seed.

In certain embodiments, the herbal ingredients can be steeped, i.e., soaked, in a liquid, e.g., water, for about 5 minutes, 10 minutes, 15 minutes, 20 minutes, 25 minutes, 30 minutes, 60 minutes.

In certain embodiments, the herbal ingredients can be steeped in a liquid, e.g., water, for about 5, 10, 15, 20, 25, 30, 40, 50, 60, 70, 80, 90, 100, 110 or 120 minutes.

In certain embodiments, the herbal ingredients can be steeped in a liquid, e.g., water, for about 5-120, 30-120, 60-120 or 90-120 minutes.

In certain embodiments, the herbal ingredients can be steeped in a liquid, e.g., water, for about 5-90, 5-60 or 5-90 minutes.

In certain embodiments, at least two of Schisandra berry, caffeine-containing fruit, fenugreek seed and Cardamom seed are steeped together in a liquid, e.g., water.

In certain embodiments, at least three of Schisandra berry, caffeine-containing fruit, fenugreek seed and Cardamom seed are steeped together in a liquid, e.g., water.

In certain embodiments, Schisandra berry, a caffeine-containing fruit, fenugreek seed and Cardamom seed are steeped together in a liquid, e.g., water.

In certain embodiments, all the herbal ingredients are steeped together in a liquid, e.g., water.

In certain embodiments, the herbal ingredients are not steeped individually in a liquid, e.g., water.

In certain embodiments, all the herbal ingredients are steeped together in a liquid, e.g., water for no more than 2 hours.

In certain embodiments, the liquid can have a temperature of about 4, 10, 15, 20, 25, 30, 35, 40, 45, 50, 55, 60, 65, 70, 75, 80, 85, 90, 95 or 100 degrees Celsius.

In certain embodiments, the herbal ingredients can be sliced, macerated or mashed.

In certain embodiments, the steeping process is repeated twice, three, four or five times.

In certain embodiments, the steeping process is not repeated.

In certain embodiments, the herbal energy drink does not contain any microorganisms (see FIG. 2B) including bacteria or yeast.

In certain embodiments, the herbal energy drink does not contain any added enzymes.

In certain embodiments, the herbal energy drink can self-acidify over a period of 0, 20, 40, 60, 80 or 100 minutes. In certain embodiments, the herbal energy drink can self-acidify to a pH of about 6, 5, 4, 3 or 2. In certain embodiments, the herbal energy drink can self-acidify to a pH of 3 (see FIG. 2C).

In certain embodiments, the herbal energy drink is hot filled into a glass container at a temperature of at least 170° F.

In certain embodiments, the self-acidification process and hot filling process preserves the herbal energy drink for about 1, 2, 3, 4, 5, 6, 7, 8, 9, 10, 15, 20, 25, 30, 60 or 90 days at 20° C.

In certain embodiments, the herbal energy drink can be preserved, for about 1, 2, 3, 4, or 5 weeks at 4° C.

In certain embodiments, the herbal energy drink can be preserved by freezing.

In certain embodiments, the herbal energy drink can be freeze dried.

In certain embodiments, the herbal energy drink contains less than 50 calories.

In certain embodiments, the herbal energy drink contains 1-50, 1-45, 1-40, 1-35, 1-30, 1-25, 1-20, 1-15, 1-10 or 1-5 calories.

In certain embodiments, the herbal energy drink contains 5-50, 10-50, 15-50, 20-50, 25-50, 30-50, 35-20, 40-50 or 45-50 calories.

In certain embodiments, the herbal energy drink contains less than 10 calories.

Schisandra berry

Schisandra chinensis or Schisandra fructus (referred to as Schisandra, also known by the names Magnolia Vine, Japanese Gomishi, Korean Omicha, and Fruit of Five Flavours) refers to a woody creeping vine with numerous clusters of tiny bright red berries that is native to Northern China and the adjacent regions of Russia and Korea. The berry of Schisandra chinensis owes its name Wu Wei Zi (five flavored berry) to the fact that it has a sweet, sour, salty, bitter and pungent flavor. As a traditional medicinal herb, Schisandra, called Wu-wei-tzu in China, has been used to treat dry coughs, asthma, night sweats and chronic diarrhea. It is also used traditionally as a tonic for the treatment of chronic fatigue.

According to the Dr. Duke's Phytochemical and Ethnobotanical database (at www.ars-grin.gov/duke/ compiled by Dr. Jim Duke of the Green Farmacy Garden and the United States Department of Agriculture (USDA)), the fruit of Schisandra chinensis contains the following chemical compounds in TABLE I.

TABLE I

| Chemical | Low PPM | High PPM |
|---|---|---|
| ALUMINUM | | 174 |
| ARSENIC | | 0.18 |
| ASCORBIC-ACID | 153 | 1022 |
| BETA-CAROTENE | 9 | 61 |
| BETA-SITOSTEROL | | |
| CALCIUM | 864 | 5760 |
| CHROMIUM | 0.3 | 1.8 |
| CITRIC-ACID | 5000 | 33333 |
| COBALT | 2 | 10.4 |
| COPPER | 5 | 11 |
| DEOXYGOMOSIN-A | | |
| FIBER | | 76000 |
| FLUORIDE | | 2.1 |
| GOMISIN-E | | 67 |
| GOMISIN-G | | 160 |
| GOMISIN-H | | 10 |
| GOMISIN-J | 230 | 380 |
| GOMISIN-N | 59 | 3100 |
| IRON | 5 | 35 |
| ISOSCHIZANDRIN | | 12 |
| LIGNANS | 3000 | 20000 |
| MAGNESIUM | 414 | 2760 |
| MALIC-ACID | 5000 | 33333 |
| MANGANESE | 0.6 | 3.7 |
| NIACIN | | |
| PEONIDIN-3-O-BETA-D-GLUCOSIDE | | |
| PHOSPHORUS | 639 | 4260 |
| POTASSIUM | 1545 | 10300 |
| PROTOCATECHUIC-ACID | | 58.3 |
| RIBOFLAVIN | 0.1 | 0.5 |
| SCHISANDRIN | | |
| SCHISANHENOL | | |
| SCHISANTHERIN-A | | |
| SCHIZANDRIN | 65 | 2600 |
| SCHIZANDROL-B | | |
| SELENIUM | 0.1 | 0.7 |
| SILICON | 0.5 | 3.4 |
| SODIUM | 15 | 97 |
| SORBIC-ACID | | |
| TANNIN | | |
| TARTARIC-ACID | 5000 | 33333 |
| THIAMIN | | 0 |
| TIN | | 940 |
| WUWEIZICHUN-B | | |
| WUWEIZISU-C | 10 | 720 |
| ZINC | | |

The berry's primary hepatoprotective (liver protecting) and immuno-modulating constituents are the lignans schizandrin, deoxyschizandrin, gomisins, and pregomisin, which are found in the seeds of the fruit. Further, schizandra is said to nourish the kidneys, astringe the kidneys and stop diarrhea, arrest excessive sweating, provide calming, generate body fluids and alleviate thirst. Subsequent Japanese studies have found that two of the lignans, wuweizisu C and gomisin A, exert their liver protective effects by functioning as antioxidants to prevent the lipid peroxidation produced by harmful substances such as carbon tetrachloride (see, e.g., the published U.S. Patent Application No. 2010/0260697, the content of which is incorporated by reference herein in its entirety).

Schisandra berry demonstrates significant adaptogenic activity. To qualify as an adaptogen, an herb must be completely safe and non-toxic, it must have broad uses for health, and it must specifically reduce stress, both mental and physical. As an adaptogen, Schisandra is a potent general tonic, decreasing fatigue, enhancing physical performance, and promoting endurance. The berry counters stress by reducing the levels of stress hormones in the blood. Additionally, Schisandra offers great benefits for athletes. In human studies Schisandra berry and its extracts have improved performance among long distance runners, skiers and gymnasts.

### Caffeine-Containing Fruit

Caffeine is an alkaloid that occurs naturally in some 60 plant species, of which cocoa beans, kola nuts, tea leaves and coffee beans are the most well-known. Other natural sources of caffeine include yerba mate, guarana berries, guayusa, and the yaupon holly. Caffeine is a methylated xanthine having the formula C₈H₁₀N₄O₂, is anhydrous and has a molecular weight of 194.19.

As used herein, caffeine is extracted from natural sources.

In certain embodiments, the herbal energy drink contains only caffeine extracted from plant products, e.g., coffee beans or roasted coffee beans.

In certain embodiments, the herbal energy drink does not contain synthetic caffeine, e.g., caffeine synthesized from urea and chloroacetic acid. The known pharmacologic actions of caffeine include: (1) the relaxation of smooth muscle, notably bronchial muscle and the stimulation of voluntary skeletal muscle, increasing the force of contraction and decreasing associated muscular fatigue, (2) caffeine stimulates all levels of the central nervous system. In oral doses of 100-200 mg, the drug stimulates the cerebral cortex producing a more rapid and clearer though flow, wakefulness, or arousal in fatigued patients and improved psychomotor coordination as well as increased capability for sustained intellectual effort and decreased reaction time, and (3) action on the kidney to produce diuresis. Maximal plasma concentrations are achieved within 1 hour. Caffeine has a half-life in plasma of 3-7 hours.

Methods and devices of infusing herbal ingredients can be found, for example, in U.S. Pat. No. 7,856,919, the content of which is incorporated by reference herein in its entirety.

In certain embodiments, the amount of caffeine in an once of the herbal energy drink can be about 1, 2, 3, 4, 5, 6, 7, 8, 9, 10, 11, 12, 13, 14, 15, 16, 17, 18, 19, 20, 21, 22, 23, 24, 25, 26,27,28,29,30, 35, 40, 45, or 50 mg.

In certain embodiments, the amount of caffeine in an once of the herbal energy drink can be about 1, 2, 3, 4, 5, 6, 7, 8, 9, 10 or 11 mg.

In certain embodiments, the amount of caffeine in an once of the herbal energy drink can be 1-11, 2-11, 3-11, 4-11, 5-11, 6-11, 7-11, 8-11, 9-11, 10-11 or 11 mg.

In certain embodiments, the amount of caffeine in an once of the herbal energy drink can be 1-11, 1-10, 1-9, 1-8, 1-7, 1-6, 1-5, 1-4, 1-3, 1-2 mg.

In certain embodiments, the amount of caffeine in an once of the herbal energy drink can be about 11 mg.

### Fenugreek

Fenugreek is an herbaceous plant of the leguminous family and is native to Western Asia, from where it has spread widely over Europe, the Mediterranean and rest of Asia. It is one of the oldest cultivated plants and through the ages has found wide application as a food, a food additive and in the traditional medicine of every region in which it has been cultivated. For example, one of its earliest uses was in Egypt where it was used as a flavoring agent in bread and other foods and as an anti-pyretic. Similarly, in India and elsewhere, the leaves, and both the ripe and unripe seeds of Fenugreek are used as vegetables and the ripe seed further, has numerous applications in the traditional medicine system of India. The seeds also function as a preservative and are added to pickles, chutneys and other similar products. In modem food practice, the seeds or the extract are used in bakery products, frozen dairy products, meat products, relish, condiments, candy, gravy sauces, gelatin puddings and in alcoholic and non-alcoholic beverages.

Fenugreek has been used in treating colic flatulence, dysentery, diarrhea, dyspepsia with loss of appetite, chronic cough, dropsy, enlargement of liver and spleen, rickets, gout and diabetes. The seed is stated to be a tonic (see, e.g., U.S. Pat. No. 6,495,175, the content of which is incorporated by reference herein in its entirety).

Modem medicine is beginning to provide confirmation of many of the traditional medicinal applications of Fenugreek. For example, it has been established that the saponins of Fenugreek and also the galactomannans contained in the mucilage of fenugreek have a beneficial effect on glucose, insulin and cholesterol metabolism. Thus, these components along with the dietary fiber contained in fenugreek have an important role in the treatment and management of several disorders such as obesity, coronary heart disease, diabetes, piles, fissures, chronic constipation & diverticulitis. The saponins mentioned above are also reported to contain active components that are anti-carcinogenic, anti-microbial and/or anti-oxidant.

Fenugreek seed contains a large number of individual compounds such as volatile oil, fixed oils, proteins, carbohydrates, resins, pigments, vitamins, minerals and others.

An exemplary analysis of the composition of fenugreek seed is shown in TABLE II.

TABLE II

| INGREDIENT | AMOUNT % |
|---|---|
| MOISTURE | 5.77 to 10.30 |
| ASH | 3.15 to 4.8 |
| FAT | 7.61 |
| REDUCING SUGARS | 2.14 |
| NON-REDUCING SUGARS | 1.54 |
| PENTOSES | 6.07 |
| METHYL PENTOSES | 3.42 |
| TOTAL NITROGEN | 4.28 |
| SOLUBLE NITROGEN | 1.56 |
| NITROGEN SOLUBLE IN ALCOHOL | 0.048 |
| TOTAL PROTEIN | 16.97 |
| ALCOHOL SOLUBLE PROTEIN | 0.30 |
| TOTAL AQUEOUS EXTRACT [COLD] | 20.52 |
| TOTAL ORGANIC EXTRACT [COLD] | 18.81 |
| TOTAL AQUEOUS EXTRACT [HOT] | 15.89 |
| TOTAL ORGANIC EXTRACT [HOT] | 15.25 |
| TOTAL ALCOHOL EXTRACT | 2.28 |
| HEMICELLULOSE | 11.98 |
| CELLULOSE | 6.40 |
| GUMS | 23.05 |
| MUCILAGE | 28.00 |
| TRIGONELLINE (C7H7O2N) | 0.1274 to 0.38 |
| FIBER | 15 to 20 |
| ETHER EXTRACT | 6.58 |
| NON - NITROGENOUS EXTRACT | 46.70 |
| TOTAL SAPONIN | 1.7 |

Data taken from LUPEZ, R C; OLMEDO, R G; AND PERULTA T; ANULES BREMATOL . . . , 2, 353-60 (1950); CA 45; 9140 b(1951))

### Cardamom

Cardamom, sometimes cardamon or cardamum, is a spice made from the seeds of several plants in the genera Elettaria and Amomum in the family Zingiberaceae. Both genera are native to South East Asia including the Indian subcontinent and Indonesia.

Cardamom is used to treat infections in teeth and gums, to prevent and treat throat troubles, congestion of the lungs and pulmonary tuberculosis, inflammation, and also digestive disorders. It is also reportedly used as an antidote for both snake and scorpion venom; to treat stomach-aches, constipation, dysentery, and other digestion problems. Cardamom has a strong, unique taste, with an intensely aromatic fragrance. One of the most expensive spices by weight, little is needed to impart the flavor. Cardamom is best stored in pod form, because once the seeds are exposed or ground, they quickly lose their flavor. The content of essential oil in the seeds is strongly dependent on storage conditions but may be as high as 8%. In the oil were found α-terpineol 45%, myrcene 27%, limonene 8%, menthone 6%, β-phellandrene 3%, 1,8-cineol 2%, sabinene 2% and heptane 2%. (Phytochemistry, 26, 207, 1987); Other sources report 1,8-cineol (20 to 50%), α-terpenylacetate (30%), sabinene, limonene (2 to 14%) and borneol.

### Natural Sweetener

Natural sweeteners may be added to the infusion of Schisandra berries, caffeine-containing fruit, fenugreek seed and Cardamom seed. A preferred natural sweetener is maple syrup.

In certain embodiments, the natural sweetener is about 6% by weight.

Any patent, patent application, publication, or other disclosure material identified in the specification is hereby incorporated by reference herein in its entirety. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict between the present explicit disclosure and a document incorporated by reference, the present explicit disclosure shall be the operative disclosure.

Although this invention has been described with a certain degree of particularity, it is to be understood that the present disclosure has been made only by way of illustration and that numerous changes to the herbal energy drink may be resorted to without departing from the spirit and the scope of the invention.

### EXAMPLES

### Example I: Steeping Process

Schisandra berries, fenugreek and cardamom seed were placed in a colander and rinsed with cold water to remove any dust particulates. Medium roast coffee beans were added, and the contents were mixed together until homogeneous. The dry ingredients were then aliquoted in roughly equal amounts into 5-micron steeping bags (2 bags per 100lbs of mix minimum). After securing each bag opening with a zip tie to prevent any leakage from the bag, the steeping bags were placed in a kettle containing water and maple syrup which was subsequently heated until boiling. After about 5 minutes, the kettle's heating component was turned off. The contents of each bag were then allowed to steep in the hot water for 60-90 minutes but no longer than 2 hours. During this time, the pH and Brix were constantly monitored at the start and end of the boiling step and at 30-minute increments thereafter. The taste of the infusion was tested about every 10 minutes. Once the product reached a pH of about ˜3.7 and the desired flavor was achieved, the steeping bags were gently squeezed to push out excess liquid and then removed from the kettle. The pH was again checked to ensure the pH was 3.8 or lower.

### Example II: Hot Fill Bottling Process

Once the steeping bags were removed from the kettle, the resulting infusion liquid was heated to about 185° F. before being transferred to a water jacketed heating tank. The infusion liquid was then delivered from the tank to glass bottles using insulated hosing. All bottles were hot filled at a minimum temperature of about 170° F. The vacuum pressure of each bottle was tested every 15 minutes to ensure a vacuum of 7 inches Hg or higher. Filled bottles were then capped and inverted for at least 5 minutes. A bottle label was affixed to the center of each bottle together with a code indicating the lot number. A shrink band was then applied to each bottle prior to packaging in pre-assembled 8 and 12 cartons and storage in master cases ready for shipment.

### Example III: Composition of an Herbal Energy Drink

The amount of each constituent of an herbal energy drink given as a percent of the total weight of the energy drink is shown in TABLE III below.

TABLE III

| FORMULA | PERCENT BY WEIGHT |
|---|---|
| Reverse Osmosis (RO) Water | 84.3 |
| Maple Syrup, medium Amber Organic | 6 |
| Bascom Maple Farms | |
| Add water and Maple Syrup to kettle | |
| Ethiopian Harrar Coffee, Coarsley Ground | 4 |
| Organic Longview Coffee/Coffee Bean | |
| Direct | |
| Schizandra Berries, Whole Organic | 3.5 |
| Starwest Botanical or Mountain Rose | |
| Herbs | |
| Fenugreek Seeds, Whole Organic | 2 |
| Starwest Botanicals or Mountain Rose | |
| Herbs | |
| Cardamom, Whole Organic Starwest | 0.2 |
| Botanicals or Mountain Rose Herbs | |

What is claimed is:

1. A composition for enhancing energy and mental stamina comprising an infusion of Schisandra berries and caffeine-containing fruit.

2. The composition of claims 1, wherein the composition does not contain artificial flavors, artificial sweeteners or artificial preservatives.

3. The composition of claim 2, wherein the composition self acidifies.

4. The composition of claim 3, wherein the composition self acidifies to a pH of about 3 to about 5.

5. The composition of claim 3, wherein the caffeine-containing fruit comprises coffee beans.

6. The composition of claim 5, wherein the coffee beans are roasted.

7. The composition of claim 3, further comprising an infusion of fenugreek seeds.

8. The composition of claim 3, further comprising an infusion of cardamom seed.

9. The composition of claim 3, further comprising an infusion of fenugreek and cardamom seed.

10. The composition of claim 9, further comprising about 6% (w/w) natural sweetener.

11. The composition of claim 10, wherein the natural sweetener comprises maple syrup.

12. The composition of claim 3, wherein an ounce of the composition comprises from about 0.1 to about 11 mg of caffeine.

13. The composition of claim 3, wherein an ounce of the composition comprises about 11 mg of caffeine.

14. The composition of claim 3, wherein an ounce of the composition comprises less than about 15 calories.

15. The composition of claim 3, wherein an ounce of the composition comprises about 2 grams of sugar.

16. A composition for enhancing energy and mental stamina consisting of an infusion of Schisandra berries, coffee beans, fenugreek seed and cardamom seed supplemented with a natural sweetener.

17. A beverage comprising the composition of claim 1.

18. A method for enhancing energy and mental stamina of a subject comprising consuming the beverage of claim 17.

19. A method for making a beverage for enhancing energy and mental stamina comprising steeping Schisandra berries, coffee beans, fenugreek seeds and cardamom seed in an aqueous solution, and adding a natural sweetener.

20. The method of claim 19, wherein the natural sweetener comprises maple syrup.
